(19) United States
(12) Patent Application Publication
(10) Pub. No.: US 2017/0251121 A1
(43) Pub. Date: Aug. 31, 2017

(54) INTEGRATED OCR APPARATUS

(71) Applicant: ILYA EVDOKIMOV, Fremont, CA (US)

(72) Inventor: ILYA EVDOKIMOV, Fremont, CA (US)

(21) Appl. No.: 15/056,671

(22) Filed: Feb. 29, 2016

(51) Int. Cl. H04N 1/00; H04N 1/028

(52) U.S. Cl. CPC H04N 1/00973; H04N 1/00005; H04N 1/00522; H04N 1/0282; H04N 2201/0063

(57) ABSTRACT

Disclosed herein is an integrated lamp and an OCR device adapted to be connected to a personal computer (PC) defining an OCR apparatus. The apparatus includes a lamp for illuminating a work space. The lamp is powered by an electrical bus. And, the lamp is adapted to receive an OCR device, which shares the electrical bus and is powered by the same. The OCR device is embedded in the lamp. The OCR device scans documents on the work space and creates optical data. The digital controller is also embedded in the lamp. The digital controller converts the optical data into digital data and sends the digital data to the PC.

### BACKGROUND OF THE INVENTION:

### Field of the Invention:

This invention relates to office equipment used on desktops and the like. More particularly, this disclosure relates to an integrated desk top lamp, an OCR device and an integrated digital controller used for digital optical function and illumination.

### Background

It is well known that the intensity of lighting can greatly affect a person's mood and their productivity. Thus, the ability to control the intensity of lighting easily and quickly can increase a person's productivity and experience in the work or home office environment.

While lighting is a key function in the office work environment, it is not the only one. The ability to organize one's desk is increasingly important in our modern, hectic working world. In an effort to remove paper from one's desk and organize one's papers, scanners have become a useful tool. In fact, a niche industry has developed over the recent time that includes organizing ones documents relating to bills and financial information. In fact, an infomercial featuring this function has received national attention. The widespread use of scanners for organization and for other purposes to make one more efficient is widely recognized.

What is missing from today's office equipment is an ability to keep the desk uncluttered. For example, the more equipment on one's desk, the less desk space for working and the more potential for clutter. What is needed is an ability to combine several different pieces of office equipment in one piece of hardware to minimize the desk foot print. It would be advantageous for example, to develop an integrated device which handles multiple functions and makes the smallest foot print possible on one's desk.

Additionally, it would be useful to have such an integrated device, which controls the illumination intensity of the lamp, and the color spectrum of illumination as well as the temperature of light. Additionally, it would be useful to have such an integrated device, which includes ability to use and create profiles for controlling lamp settings and operation. Clearly, allowing one to create a default profile as well as other custom profiles facilitates worker efficiency. The ability to thusly store and modify default profiles further facilitates worker efficiency.

### SUMMARY OF THE DISCLOSURE

In accordance with the instant disclosure of an OCR apparatus, the OCR apparatus includes an integrated lamp and an OCR device. Additionally, the OCR device is embedded into the lamp along with a digital controller. The lamp and the OCR device as well as the digital controller share the electrical bus for power and for connection to a PC. The digital controller converts optical data, namely information from the OCR device (lens and sensor) into digital data and communicates that digital data (image transferred over wire) to the PC through the electrical bus. The PC converts the digital data (image) into electronic text data. The digital data is thusly transmitted from the OCR device to the PC through the electrical bus. The bus acts as a conduit for transporting digital data as well as electrical communication as will be more fully appreciated below with respect to other exemplary embodiments.

In accordance with the objects and advantages of the invention that will be appreciated by those skilled in the art upon reading this disclosure and using the apparatus herein, a first exemplary embodiment is disclosed herein which includes:
an integrated lamp and an OCR device adapted to be connected to a personal computer (PC) defining an OCR apparatus, the apparatus comprising:
a lamp for illuminating a work space, the lamp powered by an electrical bus, and the lamp being adapted to receive:
   an OCR device, the OCR device sharing the electrical bus and being powered by the same, the OCR device being embedded in the lamp,
   the OCR device for scanning documents on the work space and thereby creating digital data; and
   a digital controller embedded in the lamp, the digital controller converting the optical data into digital data the digital controller communicating the digital data to the PC.

In an exemplary embodiment of the OCR apparatus, the apparatus includes software which resides in the PC. The software controls both lighting and OCR functions as will be more clearly described below.

### BRIEF DESCRIPTION OF THE DRAWING:

For a further understanding of the objects and advantages of the present invention, reference should be had to the following detailed description, taken in conjunction with the accompanying drawing, in which like parts are given like reference numerals and wherein:

FIG. 1 is a perspective view of the OCR apparatus positioned for use on a desk.

FIG. 2 is a perspective view of the OCR apparatus in use while mounted on a desk and connected to a PC.

FIG. 3 is a flow diagram showing the general operation of the OCR apparatus in accordance with this disclosure.

FIG. 4 is a more detailed flow diagram showing the operation of the OCR apparatus in accordance with this disclosure.

### DETAILED DESCRIPTION OF THE DISCLOSURE

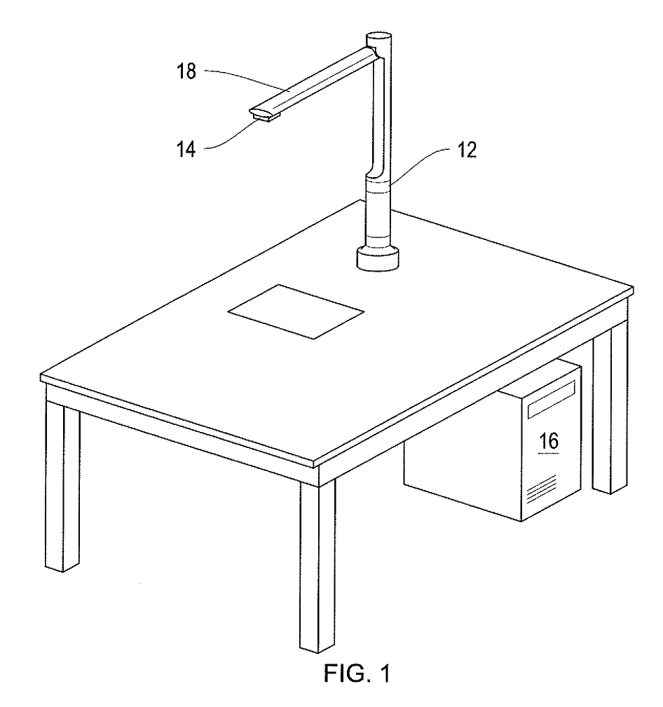

The invention will now be described with respect to FIG. 1, which illustrates a preferred embodiment of the invention shown generally by the numeral 10, an OCR apparatus. The OCR apparatus 10 includes a desk lamp 12 and OCR device 14 connected to a PC (personal computer) 16. The OCR apparatus 10 is connected to the personal computer 16 through an electrical bus (not shown). The electrical bus is shared by the OCR device 14 and the lamp 12.

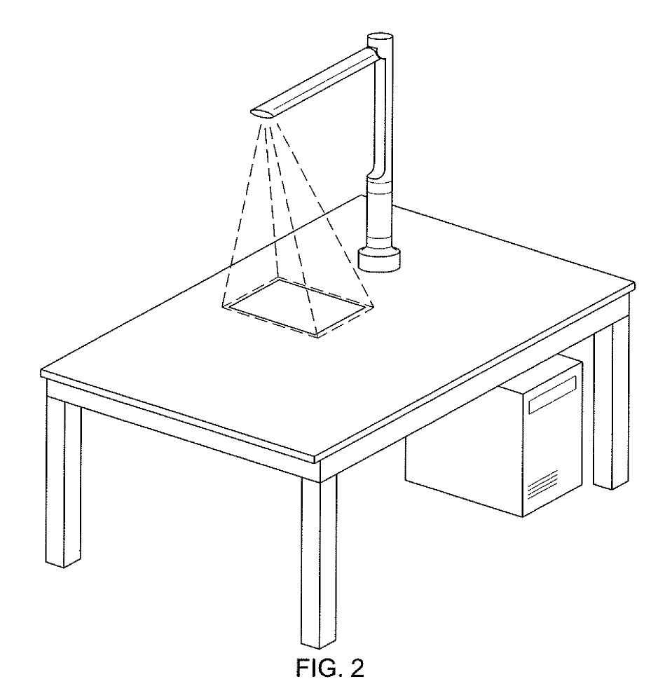

The OCR device 14 is embedded into the lamp 12. The OCR device 12 scans the documents desired and converts the image of the document into optical data and then into digital form. As shown clearly in FIG. 2, documents in the work space are scanned by the OCR device 14.

Additionally, a digital controller (not shown) is embedded in the lamp structure. The digital controller converts optical data into digital data. The digital data is then put on the electrical bus for communication with and manipulation by the PC.

In an exemplary embodiment, the OCR apparatus 10 includes software for carrying out each of the apparatus 10's functions. Additionally, the PC includes software for controlling the illumination and cooperating OCR function. By including such software the OCR apparatus 10 defines a smart lamp. The functions included are the following:
capture,
preservation,
organization,
automation,
image correction (including rotation, cleanup, background removal, and page border detection)
hand gestures detection,
magnification, and
voice commands detection.

Additionally, the provided software also facilitates and controlling illumination through the PC. In addition, in an exemplary embodiment lighting is provided with a lamp capable of changing color and the PC software includes the function of programing the lamp illumination for various color schemes. As is well known, mood light can enhance worker performance. It is dependent most particularly on the individual worker and his or her daily bio-rhythms. Once certain patterns are established, a program can be run to optimize worker performance. Lamp Illumination:

The lamp 12 includes eco-friendly LEDs for providing illumination. In an exemplary embodiment, the lamp 12 is powered through a USB cord. Similarly, the OCR device shares the USB cord and is powered by the same.

The lamp includes a touch-sensor (not shown). Additionally, the lamp 12 includes a touch-less on-off function. A sensor 18 on the top of the lamp 12 provides illumination control directly through the lamp. In order to control the illumination, the sensor 18 is touched in one exemplary embodiment. In another exemplary embodiment, touch-less hand gestures over the sensor 18 control the illumination of the lamp 12.

In another exemplary embodiment, the lamp 12 includes multiple touch sensors 18. Each sensor 18 is programmed to perform various designated functions including illumination and color schemes. These functions are programed for each user. And, one user may have a variety of different programs depending upon the goal of illumination enhancement desired.

Additionally, in an exemplary embodiment the PC includes software for programming the OCR device. In an exemplary embodiment, the OCR device includes an HD camera. The OCR device includes memory capability. Thus, even when disconnected from the PC 16, the camera remembers the settings assigned to each touch sensor 18.

In addition to illumination intensity, the PC through the software controls the color of the lighting across a full color spectrum. Additionally, the software controls the temperature of the lighting.

The PC software is used to create and store in memory, various user illumination profiles. Depending upon the goal of the program, the user profile includes various programs to combine illumination intensity, color and temperature. Providing this shortcut allows a user to change settings with one click or a hand gesture. And, the program, in an exemplary embodiment, includes default profiles with the installation. After installation, the user creates custom profiles, which can be adjusted through use, commonly known as trial and error.

The software program is also used to increase productivity through scheduled illumination programs. Such programs are PC clock based and run on the clock found in the PC 18. The schedule includes on and off periods, and the programming includes options to program various productivity, intensity, color programs during each period.

The lamp 12 includes a series of LED's for providing consistent lighting. The HD camera used by the OCR device detects ambient light and works in a complementary manner with the LED lighting to produce consistent lighting level for maximizing the clarity and richness of the optical data and providing consistent lighting throughout the day as ambient lighting changes.

As noted above, the lamp includes the ability to change the illumination color. This is sometimes known as mood lighting. In an exemplary embodiment the lamp 12 includes a full spectrum of color across the red, blue and, green frequencies.

In another exemplary embodiment, the lamp 12 includes slow fade lighting. The illumination is slowly lowered or increased. Thus, the illumination slowly fades (or increases) including all colors.

In another exemplary embodiment, the apparatus 10 includes a “Disco Party” mode. The apparatus 10 includes a microphone which detects sound frequency and beats. The lamp sensor relays these to the PC and when the mode is activated the PC instructs the apparatus 10 to flash various colors in accordance with the beat of the music.

In another exemplary embodiment, the apparatus 10 includes “Notifications” mode, wherein various events can be set for alarms to the user. For example, such events can include new e-mail, weather alert, stock market quotes, Amber alerts and the like. These events are optionally custom programmed and produce flash/beep notifications and even distinguish between various colors coded alerts.

In another exemplary embodiment, the apparatus 10 includes the capability of following voice commands. Such voice commands include activating the camera and illumination functions. Additionally, voice commands are used produce voice memos which are recorded and stored in the PC 16.

Additionally, voice commands are used to invoke and perform typical computer tasks, such as activating the scanner and opening a web page and showing weather forecasts.

### Online Features

Additionally, the programming found in the PC 16 enables the programming and optical digital data to be stored on a long-term cloud backup and storage. In fact, it is envisioned that users will be subscribers and will enable cloud document backup on a subscription basis. This will provide a low-cost, long-term secure cloud backup and storage.

Additionally, the software programming will include the ability for automatic updates online. For example, when the auto-update setting is enabled, a user's software will automatically be updated once per year. Of course, other periodic intervals are within the spirit and scope of the invention.

In an exemplary embodiment, the software of the apparatus 10 includes the ability to gather statistics. For example, it is envisioned that during syncs and updates, the software checks and records statistics including the number of pages, number of documents, what settings were used, what profiles were used, time of day per document processed, geographical locations, speed of processing, generic PC hardware information and the like. The results of this processing are internal and not shared, so that they are kept private.

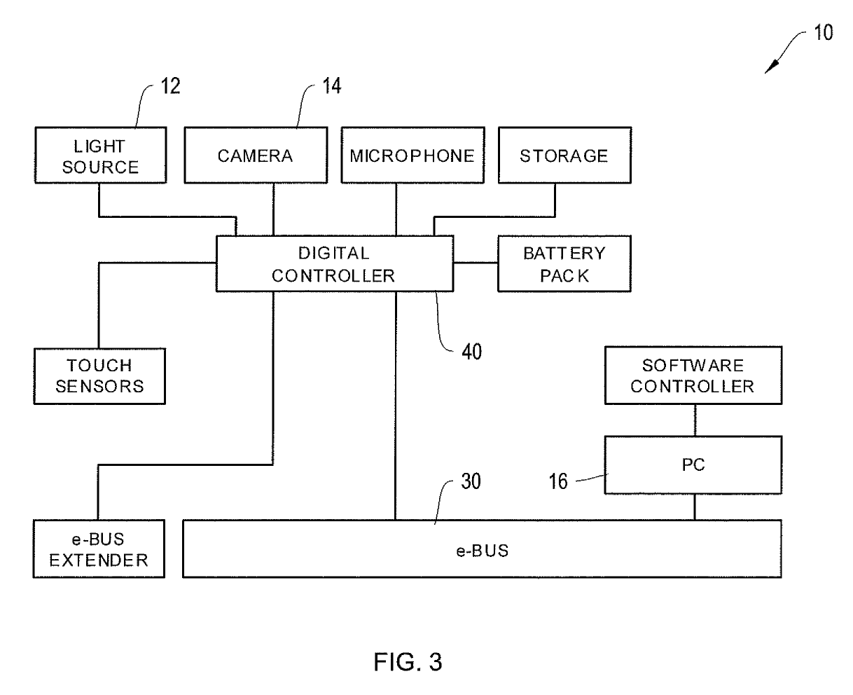

With respect to FIG. 3, there is shown in schematic representation, the organization and operation of the OCR apparatus 10. As described above, the apparatus 10 includes a lamp 12 and an OCR device 14. The apparatus includes an electrical bus 30, which is shared by both the lamp 12 and the OCR device 14. As described above, the apparatus 10 includes a digital controller 40 for converting optical data into digital data. The digital controller 40 communicates with the electrical bus 30 and places the converted optical data on the bus 30 for transmission to the PC 16.

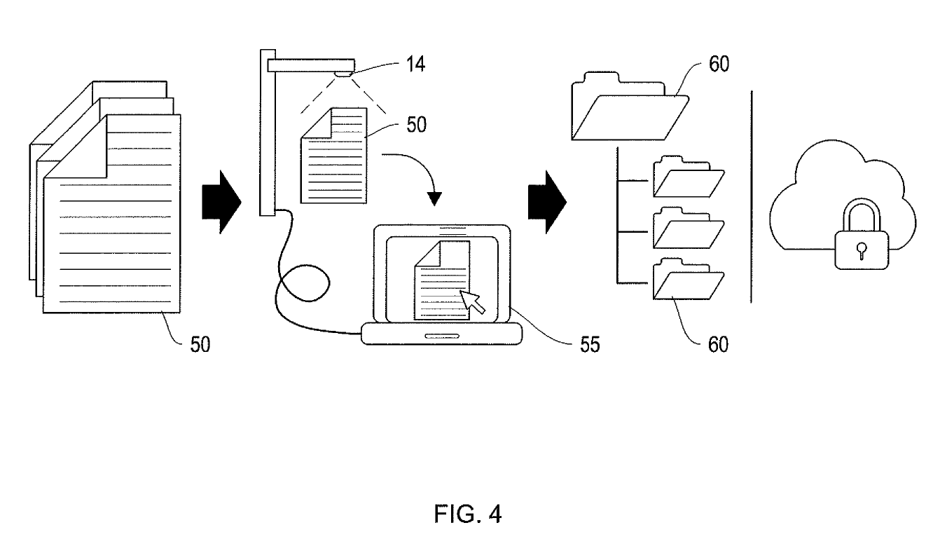

With particular reference to FIG. 4, there is shown a detail operational flow of the OCR apparatus 10 in accordance with the disclosure herein. As shown, a document 50 is placed on the work space as shown in FIG. 2. The document 50 is scanned and captured electronically by the OCR device 14. The image capture schematically represented by numeral 55. Upon capture, and after digital conversion, in an exemplary embodiment, the data is stored in to the desired folders represented by numeral 60. In another exemplary embodiment of the apparatus 10, the data it is stored in the cloud as described above.

In another exemplary embodiment, the apparatus 10 includes the capability of acting as a security camera. When placed in the security mode at the PC, the camera will do video recording and remote monitor its location. In another exemplary embodiment, the camera is pointed away from the desk surface.

In another exemplary embodiment, the camera is online and acts as a video streaming device to broadcast desk surface workspace.

In another exemplary embodiment, the camera detects movement, for example, a document is placed on the work surface or when a hand stops moving or when a motion occurs on the desk.

In another exemplary embodiment, the apparatus 10 in cooperation with the PC extracts text for purposes of automatic document archiving and for future searching. In an exemplary embodiment, the apparatus 10 performs this function without manually naming each document or manually managing folders.

In another exemplary embodiment, the apparatus 10 includes a software training mode to teach the software to recognize known repeating formats or documents and process them automatically.

In another exemplary embodiment, the camera is used as a video presenting device to broadcast, photograph and/or video record, the workspace.

In another exemplary embodiment, the camera is used as a digital magnifying glass device for close-ups of the desk surface workspace. Using this embodiment, the documents appear larger than actual size on the screen. This provides a life-enhancing aid for visually impaired users. It also serves as a means for optimizing productivity for users working with very small items.

In another exemplary embodiment, the camera is used as a digital microscope device to greatly zoom-in and close-up desk surface workspace to reveal details more than visible to human eye.

While the foregoing detailed description has described several embodiments of the OCR apparatus in accordance with this disclosure, it is to be understood that the above description is illustrative only and not limiting of the disclosed OCR apparatus. It will be appreciated that the embodiments discussed above and the virtually infinite embodiments that are not mentioned could easily be within the scope and spirit of this invention. Thus, the invention is to be limited only by the claims as set forth below.

1. An integrated lamp and an OCR device adapted to be connected to a personal computer (PC) defining an OCR apparatus, the apparatus comprising:
a lamp for illuminating a work space, the lamp powered by an electrical bus, and the lamp being adapted to receive:
an OCR device, the OCR device sharing the electrical bus and being powered by the same, the OCR device being embedded in the lamp, the OCR device for scanning documents on the work space and thereby creating digital data; and
a digital controller embedded in the lamp, the digital controller converting the optical data into digital data, the digital controller communicating the digital data to the PC.

2. The apparatus as set forth in claim 1, wherein the OCR apparatus includes software for carrying out each function of OCR apparatus.

3. The apparatus as set forth in claim 2, wherein the software resides in the PC and controls each operation and function of the OCR apparatus.

4. The apparatus as set forth in claim 2, wherein the software includes smart tools for performing the following functions:
capture,
preservation,
organization,
automation,
image correction (including rotation, cleanup, background removal, and page border detection)
hand gestures detection,
magnification, and
voice commands detection.

5. The apparatus as set forth in claim 1, wherein the PC controls the operations and functions of the OCR apparatus, including the OCR device and the lamp.

6. The apparatus as set forth in claim 5, wherein the lamp includes a touch sensor function for controlling the illumination.

7. The apparatus as set forth in claim 6, wherein the OCR device includes a high definition camera.

8. The apparatus as set forth in claim 1, wherein the OCR apparatus is connected to the PC through a USB cable.

9. The apparatus as set forth in claim 1, wherein the OCR apparatus includes software controlling:
capture,
preservation,
organization,
automation,

10. An general purpose lamp integrated with an OCR device adapted to be connected to a personal computer (PC) defining an OCR apparatus, the apparatus comprising:
a general purpose lamp for illuminating a work space, the lamp powered by an electrical bus, and the lamp being adapted to receive:
an OCR device, the OCR device sharing the electrical bus and being powered by the same, the OCR device being embedded in the lamp, the OCR device for scanning documents on the work space and thereby creating digital data; and
a digital controller embedded in the lamp, the digital controller converting the optical data into digital data, the digital controller communicating the digital data to the PC.
image correction (including rotation, cleanup, background removal, and page border detection)
hand gestures detection,
magnification, and
voice commands detection.
